(19) United States
(12) Patent Application Publication
(10) Pub. No.: US 2023/0003326 A1
(43) Pub. Date: Jan. 5, 2023

(54) MIXING VALVE ADAPTER

(71) Applicants: Tim O'Connor, Lewellen, NE (US); Shawn Stapp, Strasburg, CO (US)

(72) Inventors: Tim O'Connor, Lewellen, NE (US); Shawn Stapp, Strasburg, CO (US)

(21) Appl. No.: 17/809,186

(22) Filed: Jun. 27, 2022

Related U.S. Application Data
(60) Provisional application No. 63/202,918, filed on Jun. 30, 2021.

(51) Int. Cl. F16L 41/03

(52) U.S. Cl. CPC F16L 41/03; F16K 19/006

(57) ABSTRACT

A mixing valve adapter is disclosed for a sink faucet with a mixing valve. An example mixing valve adapter includes an adapter body formed as a rigid unitary structure that does not flex so that the mixing valve is mounted rigid to the sink faucet without separately mounting the mixing valve apart from the sink faucet. The example mixing valve adapter also includes a first valve connection on the adapter body for connecting mixed cold and hot water from the mixing valve, and a first faucet connection on the adapter body for connecting the mixed cold and hot water to the sink faucet. The example mixing valve adapter also includes a second valve connection on the adapter body for connecting cold water from the mixing valve, and a second faucet connection on the adapter body for connecting the cold water to the sink faucet.

### PRIORITY CLAIM

This application claims the priority filing benefit of U.S. Provisional Patent Application No. 63/202,918 filed Jun. 30, 2021 for “Mixing Valve Adapter” of O'Connor and Stapp, hereby incorporated by reference in its entirety as though fully set forth herein.

### BACKGROUND

Lavatory mixing valves are provided under some sinks to mix hot and cold water. Mixing valves may aid to minimize the risk of scalding. Mixing valves may have flow characteristics and check valves to protect against cross flow.

Installing mixing valves with conventional flex lines in the cabinets under sinks can be time consuming. Once installed, the flex links can kink, are messy in appearance, and interfere with the cabinet space under the sink.

### BRIEF DESCRIPTION OF THE DRAWINGS

FIG. 1 is a bottom perspective view of an example mixing valve adapter.

FIG. 2 is a side view of the example mixing valve adapter shown in FIG. 1.

FIG. 3 is a bottom view of the example mixing valve adapter shown in FIG. 1.

FIG. 4 is a cross-section view of the example mixing valve adapter taken along lines 4-4 in FIG. 3.

FIGS. 5 and 6 are bottom perspective views of an example mixing valve adapter shown with fittings.

FIG. 7 is a side view of the example mixing valve adapter with fittings shown in FIGS. 5 and 6.

FIG. 8 is a top view of the example mixing valve adapter with fittings shown in FIGS. 5 and 6.

FIG. 9 is a cross-section view of the example mixing valve adapter taken along lines 9-9 in FIG. 8.

FIG. 10 is a perspective view of the example mixing valve adapter shown as it may be connected to a sink faucet.

FIG. 11 is a front view of the example mixing valve adapter connected to a sink faucet as shown in FIG. 10.

FIG. 12 is a perspective view of the example mixing valve adapter shown as it may be cut and connected to a single inlet sink faucet.

FIG. 13 is a front view of the example mixing valve adapter connected to a single inlet sink faucet as shown in FIG. 12.

### DETAILED DESCRIPTION

Mixing valves installed in the cabinets under lavatory sinks can be time consuming, the installation can be messy in appearance, and the connections often interfere with the cabinet space under the sink.

A mixing valve adapter is disclosed for a sink faucet with a mixing valve. The mixing valve adapter may be a unitary (e.g., single or one piece) rigid connection that is compact and easy to install with conventional 4-port mixing valves in the cabinet under sinks.

An example mixing valve adapter includes an adapter body to connect between the sink faucet and the mixing valve. The adapter body is formed as a rigid unitary structure that does not flex so that the mixing valve is mounted rigid to the sink faucet without separately mounting the mixing valve apart from the sink faucet. The example mixing valve adapter also includes a first valve connection on the adapter body for connecting mixed cold and hot water from the mixing valve. The example mixing valve adapter also includes a first faucet connection on the adapter body for connecting the mixed cold and hot water to the sink faucet. The example mixing valve adapter also includes a second valve connection on the adapter body for connecting cold water from the mixing valve. The example mixing valve adapter also includes a second faucet connection on the adapter body for connecting the cold water to the sink faucet.

In an example, the mixing valve adapter also includes a bridge formed between the first side of the adapter body with the first valve connection and the first faucet connection, and the second side of the adapter body with the second valve connection and the second faucet connection. The bridge may have a solid cross section (in all orientations, i.e., it is solid) that the bridge is fluidically independent from the second side of the adapter body. As such, the bridge can be cut to separate the first side of the adapter body from the second side of the adapter body (without opening the water line).

In an example, the first faucet connection and the second faucet connection to the sink faucet are compression fittings. In an example, the first valve connection and the second valve connection are connected to the mixing valve by union fittings.

In an example, a first compression riser is provided to form a compression fitting with the first valve connection. A second compression riser is provided to form a compression fitting with the second valve connection.

In an example, an end cap is provided for the adapter body. The end cap may be removable for testing or cleaning (e.g., unclogging) the mixing valve adapter.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

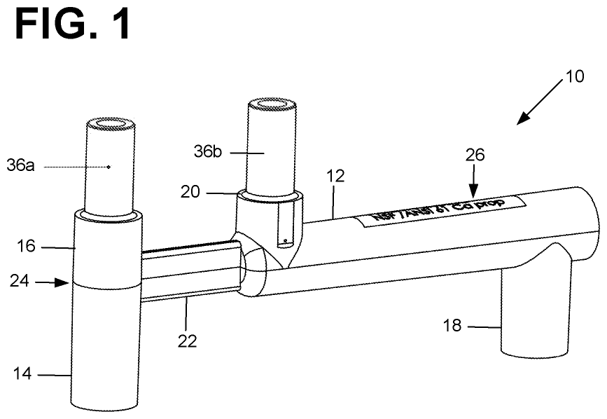

FIG. 1 is a bottom perspective view of an example mixing valve adapter 10. The mixing valve adapter may be implemented for a sink faucet with a mixing valve, and is installed, typically under the lavatory or kitchen cabinet, in-line between the sink faucet and the mixing valve. That is, the cold and hot water supply lines are attached to the mixing valve. The mixing valve is connected to the mixing valve adapter 10, and the mixing valve adapter 10 is connected to the sink faucet.

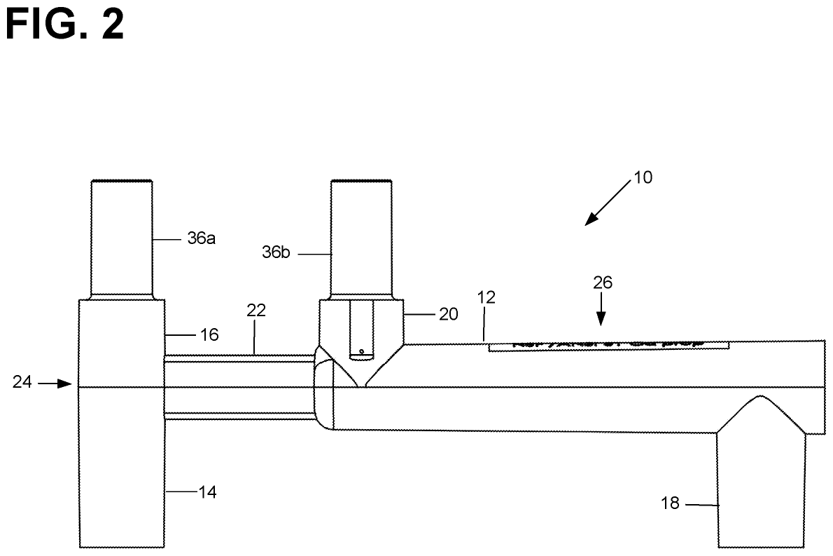

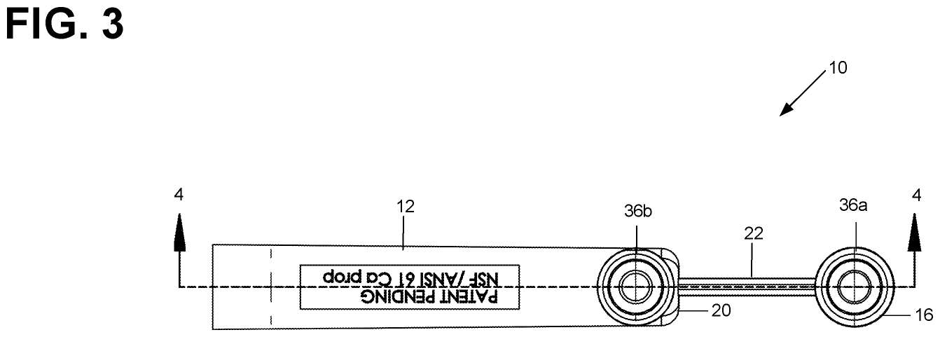

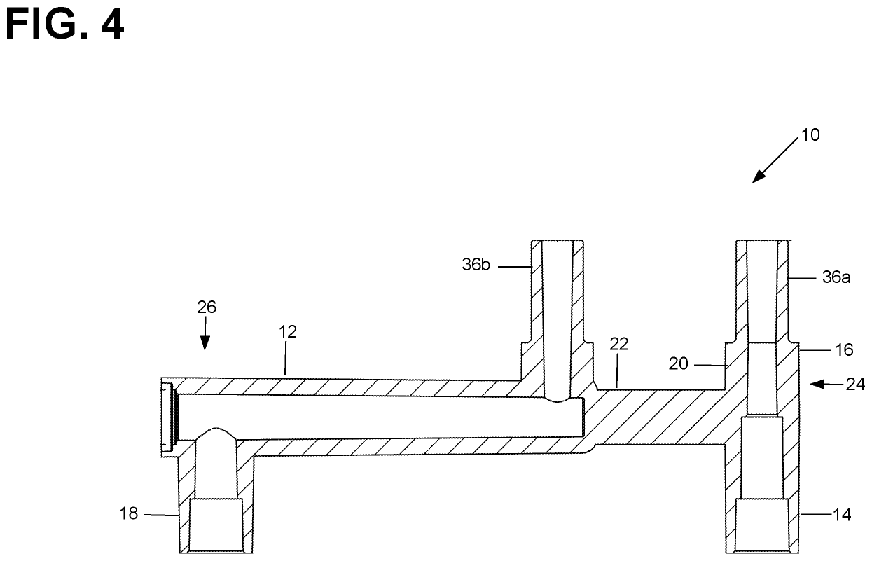

FIG. 2 is a side view of the example mixing valve adapter 10 shown in FIG. 1. FIG. 3 is a bottom view of the example mixing valve adapter 10 shown in FIG. 1. FIG. 4 is a cross-section view of the example mixing valve adapter 10 taken along lines 4-4 in FIG. 3.

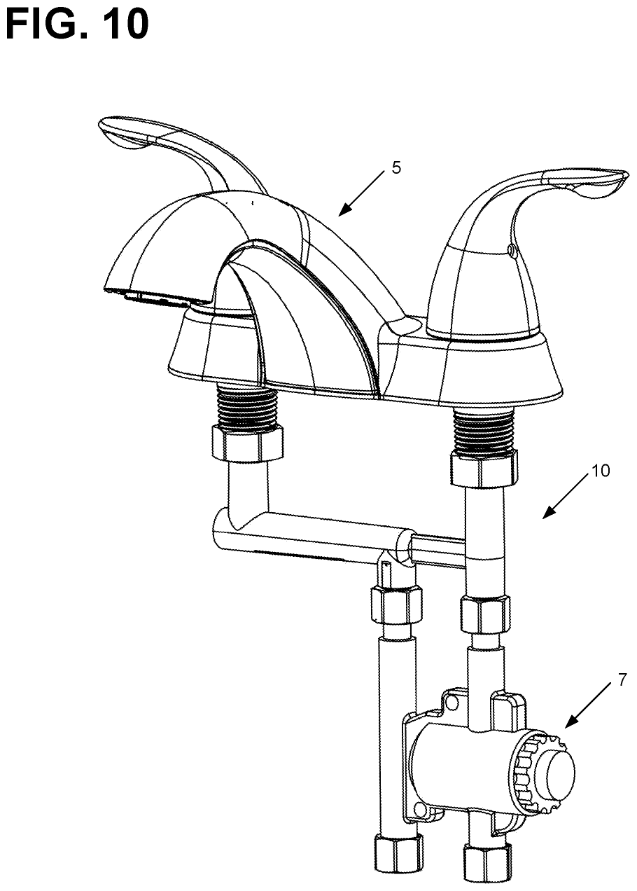

In an example, the mixing valve adapter 10 includes an adapter body 12 to connect between the sink faucet and the mixing valve. See, e.g., FIGS. 10-13 described below. The adapter body 12 includes a first valve connection 14 for connecting mixed cold and hot water from the mixing valve to the mixing valve adapter 10. The adapter body 12 also includes a first faucet connection 16 for connecting the mixed cold and hot water from the mixing valve adapter 10 to the sink faucet. The adapter body 12 also has a second valve connection 18 for connecting cold water from the mixing valve to the mixing valve adapter 10. A second faucet connection 20 is provided on the adapter body 12 for connecting the cold water from the mixing valve adapter 10 to the sink faucet.

It is noted that the mixing valve adapter 10 need not be installed with a mixing valve. In other examples, the cold and/or hot water supply lines may be connected directly to the mixing valve adapter 10, which is then connected to the sink faucet.

In an example, the adapter body 12 is rigid and does not flex so that the mixing valve is mounted rigid to the sink faucet without having to separately mount the mixing valve apart from the sink faucet (e.g., to the sink cabinet as may otherwise be required to reduce or prevent vibration).

In an example, the adapter body 12 is formed as a unitary structure. That is, the adapter body 12 is formed in a mold. A gate 1 formed by the injection mold can be seen in FIG. 1.

In an example, the adapter body 12 includes a bridge 22 formed between a first side 24 of the adapter body 12 (i.e., the side with the first valve connection 14 and the first faucet connection 16), and a second side 26 of the adapter body 12 (i.e., the side with the second valve connection 18 and the second faucet connection 20).

In an example, the bridge 22 is a fixed length (e.g., 4 inches, or 6 inches, or 8 inches). Any suitable length may be provided depending at least to some extent on the intended installation (e.g., separation of the cold and hot water inlets on the sink faucet). In another example, the bridge 22 has an adjustable length (e.g., can be slid or rotated to adjust the length between 4 to 8 inches or other suitable length adjustment) for use in different installation settings with different types of sink faucets.

In an example, the bridge 22 may have a solid cross section. See, e.g., FIG. 4. That is, the first side 24 of the adapter body 12 is fluidically independent from the second side 26 of the adapter body 12. That is, there is no water flow passage through the bridge 22.

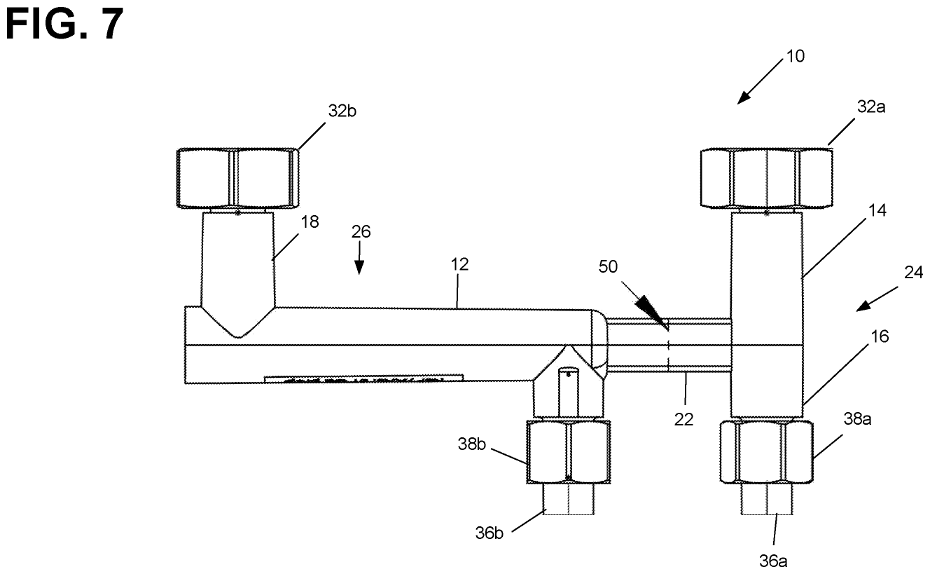

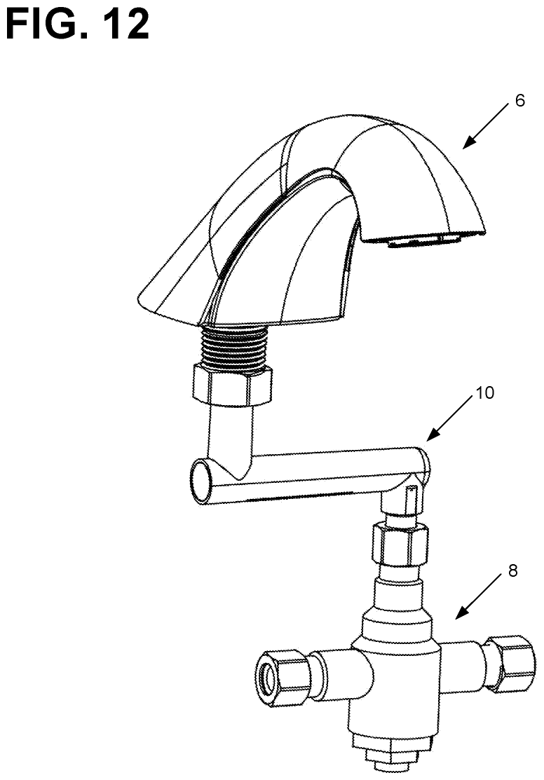

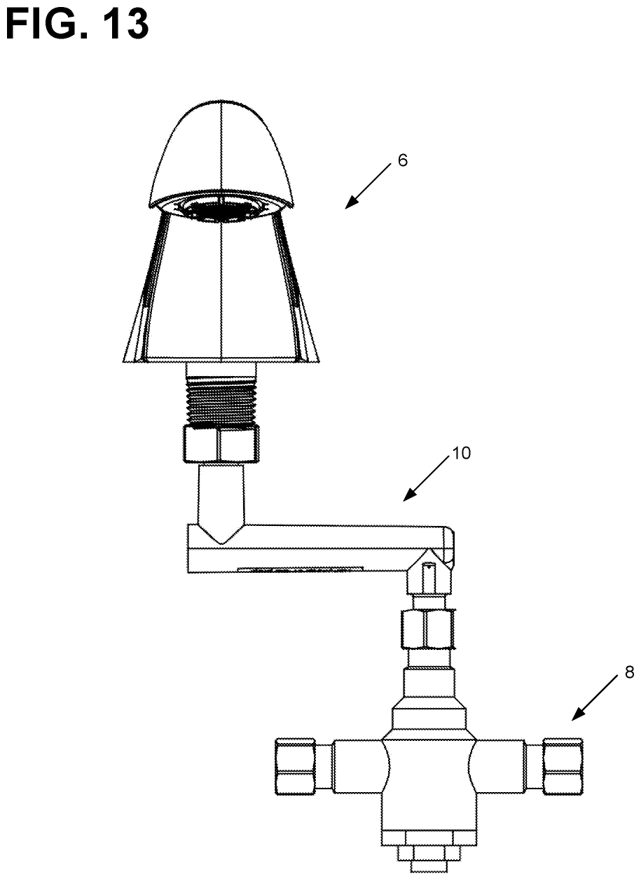

In an example, the bridge 22 may be cut (e.g., using a hacksaw along cut line 50 in FIG. 7) to separate the first side 24 of the adapter body 12 from the second side 26 of the adapter body 12, as illustrated in FIGS. 12 and 13. Such a configuration may be implemented when the sink faucet only has a single inlet connection, such as for a sensor faucet, as illustrated by way of example in FIGS. 12 and 13 described below.

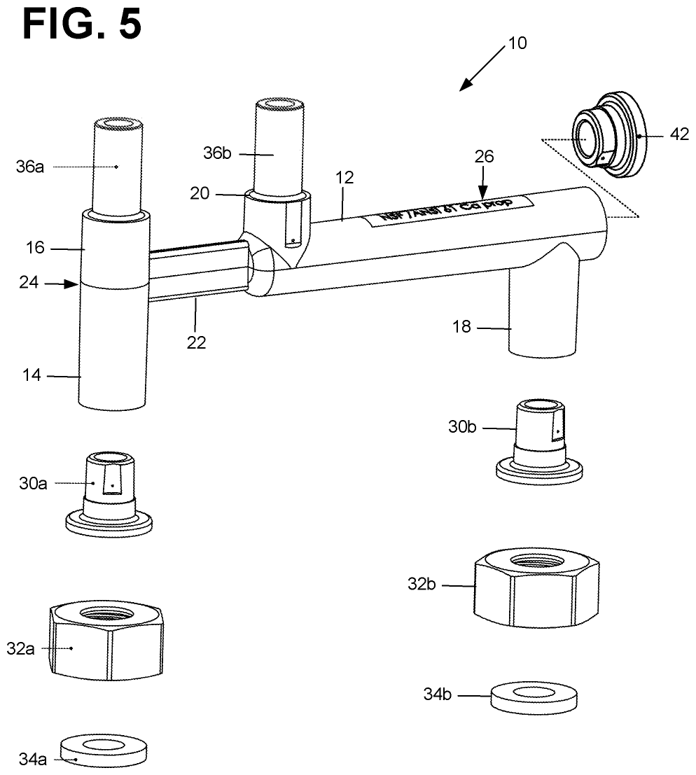

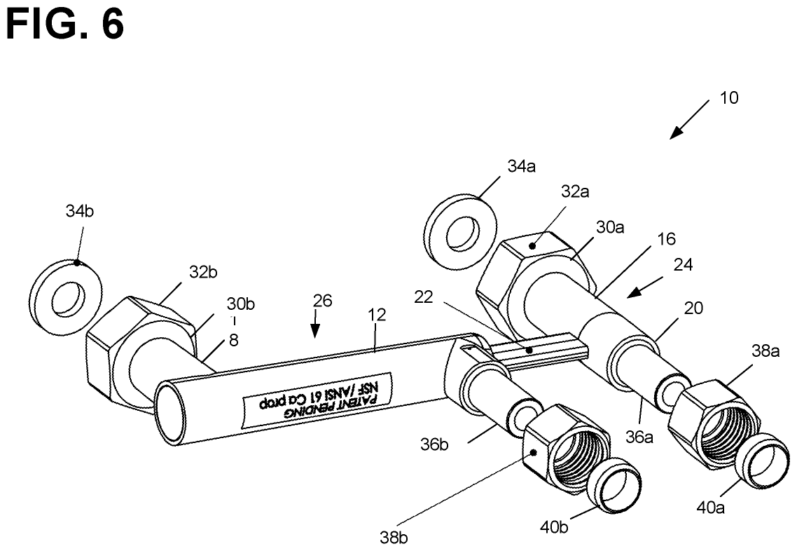

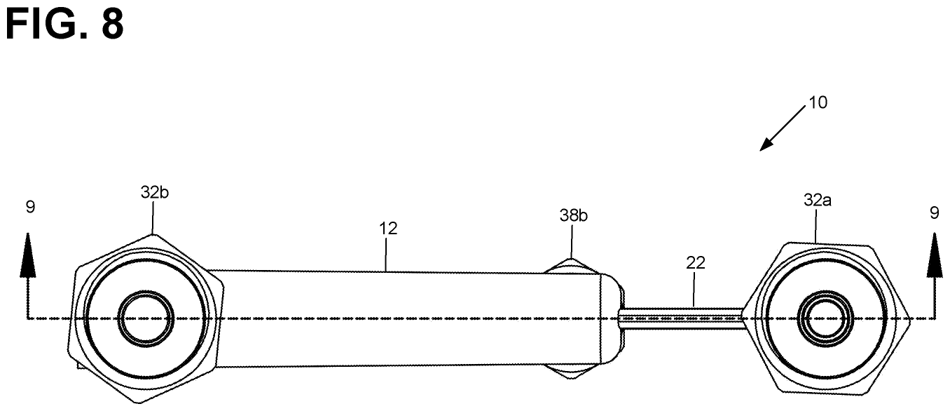

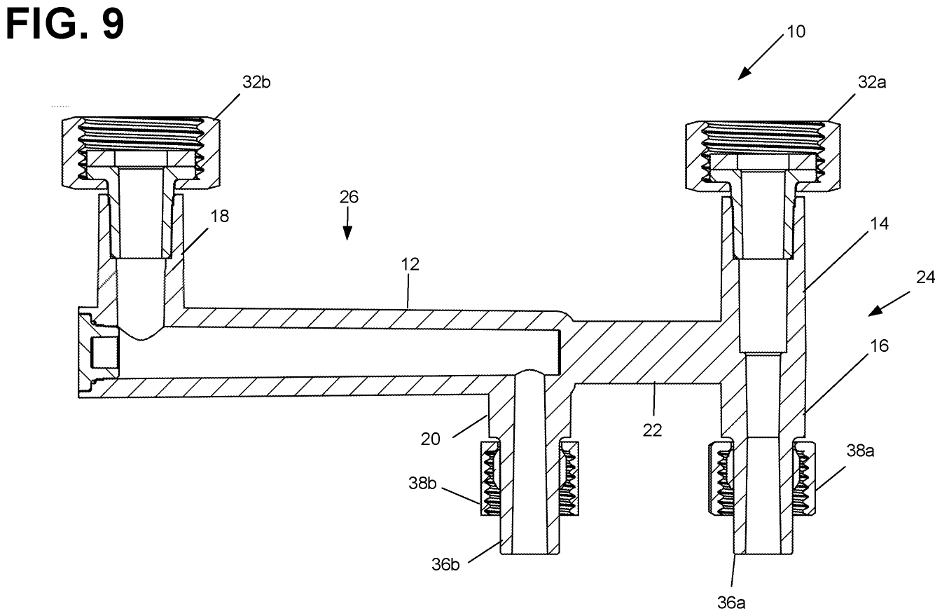

FIGS. 5 and 6 are bottom perspective views of an example mixing valve adapter 10 shown with connection fittings. FIG. 7 is a side view of the example mixing valve adapter 10 with the fittings shown in FIGS. 5 and 6. FIG. 8 is a top view of the example mixing valve adapter 20 with the fittings shown in FIGS. 5 and 6. FIG. 9 is a cross-section view of the example mixing valve adapter 10 taken along lines 9-9 in FIG. 8.

In an example, the fittings may include union fittings (e.g., adapter 30a, 30b, union nut 32a, 32b, and a rubber or other sealing washer 34a, 34b). In an example, the first valve connection 14 and the second valve connection 18 are each connected to the mixing valve by union fittings.

In an example, the fittings may include compression fittings (e.g., compression risers 36a, 36b, compression nut 38a, 38b, and compression ring 40a, 40b). Compression risers or adapters 36a, 36b are shown installed into the first faucet connection 16 and the second faucet connection 20. In an example, the first faucet connection 16 and the second faucet connection 20 to the sink faucet are compression fittings.

It is understood that the mixing valve adapter 10 may be configured in any suitable manner so as to provide connections via any fittings now known or later developed that are suitable for water lines. For example, all of the connections may be compression fittings, all of the connections may be union fittings, some or all of the connections may be slip fit connections or push-to-connect fittings (e.g., SHARKBITE™). The mixing valve adapter 10 is not limited to the connections shown and described herein except to the extent a particular embodiment may be described by the claims.

In an example, the body 12 of the mixing valve adapter 10 may include a removable end cap 42, shown for example in FIG. 5 and FIG. 9. In another example, the end of the body 12 may be permanently closed (e.g., during manufacture.

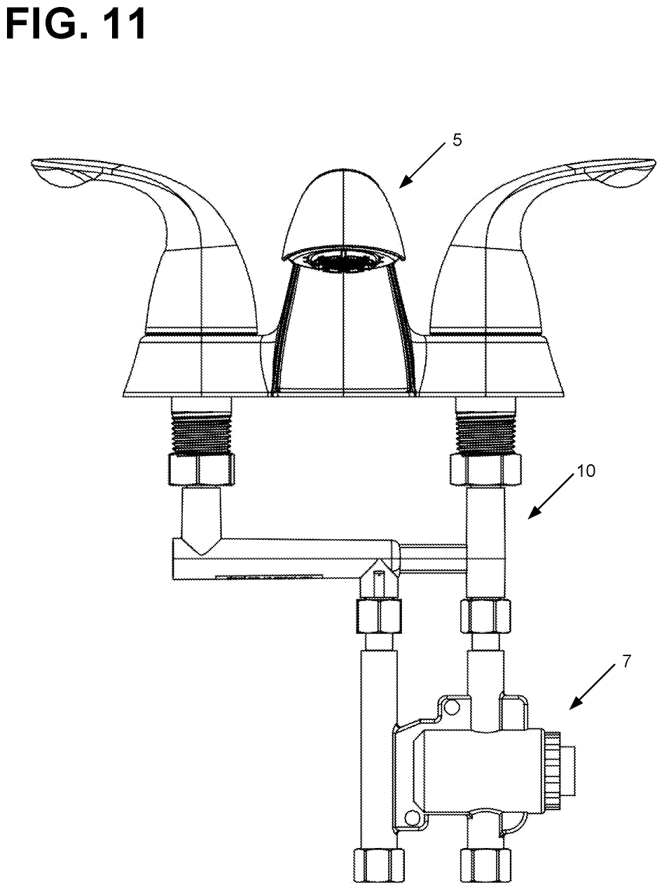

FIG. 10 is a perspective view of the example mixing valve adapter 10 shown as it may be connected between a sink faucet 5 and a mixing valve 7. FIG. 11 is a front view of the example mixing valve adapter 10 connected to the sink faucet 5 and the mixing valve 7, as shown in FIG. 10.

FIG. 12 is a perspective view of the example mixing valve adapter 10 shown as it may be cut (e.g., on bridge 22) and connected to between a single inlet sink faucet 6 and a mixing valve 8. FIG. 13 is a front view of the example mixing valve adapter 10 connected to the single inlet sink faucet 6 and and mixing valve 8, as shown in FIG. 12.

It is noted that the examples shown and described are provided for purposes of illustration and are not intended to be limiting. For example, components may be separately molded and assembled to form all or part of the mixing valve adapter described herein, and/or one or more of the components may be molded as a unitary structure. In addition, while the mixing valve adapter has been described as it may be used primarily for the installation of sink faucets with mixing valves, it will be readily apparent to those having ordinary skill in the art after becoming familiar with the teachings herein, that the mixing valve adapter may be modified for use in other applications and is not to be limited to any particular end-use. Still other examples are also contemplated.

1. A mixing valve adapter for a sink faucet with a mixing valve, comprising:
an adapter body to connect between the sink faucet and the mixing valve;
a first valve connection on the adapter body for connecting mixed cold and hot water from the mixing valve;
a first faucet connection on the adapter body for connecting the mixed cold and hot water to the sink faucet;
a second valve connection on the adapter body for connecting cold water from the mixing valve;
a second faucet connection on the adapter body for connecting the cold water to the sink faucet.

2. The mixing valve adapter of claim 1, wherein the adapter body is rigid and does not flex so that the mixing valve is mounted rigid to the sink faucet without separately mounting the mixing valve apart from the sink faucet.

3. The mixing valve adapter of claim 1, wherein the adapter body is formed as a unitary structure.

4. The mixing valve adapter of claim 1, further comprising a bridge formed between a first side of the adapter body with the first valve connection and the first faucet connection, and a second side of the adapter body with the second valve connection and the second faucet connection.

5. The mixing valve adapter of claim 4, wherein the bridge has a solid cross section.

6. The mixing valve adapter of claim 4, wherein the first side of the adapter body is fluidically independent from the second side of the adapter body.

7. The mixing valve adapter of claim 4, wherein the bridge is cut to separate the first side of the adapter body from the second side of the adapter body.

8. The mixing valve adapter of claim 4, wherein the bridge has a fixed length.

9. The mixing valve adapter of claim 4, wherein the bridge has an adjustable length.

10. The mixing valve adapter of claim 1, wherein the first faucet connection and the second faucet connection to the sink faucet are compression fittings.

11. The mixing valve adapter of claim 1, wherein the first valve connection and the second valve connection are union fittings.

12. The mixing valve adapter of claim 11, further comprising a first compression riser to form the compression fitting of the first valve connection, and a second compression riser to form the compression fitting of the second valve connection.

13. The mixing valve adapter of claim 1, further comprising an end cap for the adapter body.

14. A mixing valve adapter for a sink faucet with a mixing valve, comprising:
an adapter body to connect between the sink faucet and the mixing valve, the adapter body formed as a rigid unitary structure that does not flex so that the mixing valve is mounted rigid to the sink faucet without separately mounting the mixing valve apart from the sink faucet;
a first valve connection on the adapter body for connecting mixed cold and hot water from the mixing valve;
a first faucet connection on the adapter body for connecting the mixed cold and hot water to the sink faucet;
a second valve connection on the adapter body for connecting cold water from the mixing valve; and
a second faucet connection on the adapter body for connecting the cold water to the sink faucet.

15. The mixing valve adapter of claim 14, further comprising a bridge formed between a first side of the adapter body with the first valve connection and the first faucet connection, and a second side of the adapter body with the second valve connection and the second faucet connection.

16. The mixing valve adapter of claim 15, wherein the bridge has a solid cross section that is fluidically independent from the second side of the adapter body.

17. The mixing valve adapter of claim 15, wherein the bridge is cut to separate the first side of the adapter body from the second side of the adapter body.

18. The mixing valve adapter of claim 14, wherein the first faucet connection and the second faucet connection to the sink faucet are union fittings, and wherein the first valve connection and the second valve connection are each connected to the mixing valve by a compression fitting.

19. The mixing valve adapter of claim 14, further comprising a first compression riser to form a compression fitting with the first valve connection, and a second compression riser to form a compression fitting with the second valve connection.

20. The mixing valve adapter of claim 14, further comprising an end cap for the adapter body.
